(19) United States
(12) Patent Application Publication
(10) Pub. No.: US 2019/0012110 A1
(43) Pub. Date: Jan. 10, 2019

(54) INFORMATION PROCESSING APPARATUS, AND CONTROL METHOD OF INFORMATION PROCESSING SYSTEM

(71) Applicant: FUJITSU LIMITED, Kawasaki-shi (JP)

(72) Inventors: KENJI OKANO, Kawasaki (JP); Kenji Tagashira, Kawasaki (JP); Takafumi ANRAKU, Kawasaki (JP)

(73) Assignee: FUJITSU LIMITED, Kawasaki-shi (JP)

(21) Appl. No.: 16/026,094

(22) Filed: Jul. 3, 2018

(30) Foreign Application Priority Data
Jul. 6, 2017 (JP) 2017-132554

(51) Int. Cl. G06F 3/06; G06F 12/10; G06F 9/455

(52) U.S. Cl. CPC G06F 3/0647; G06F 3/0604; G06F 3/0659; G06F 3/0664; G06F 3/0683; G06F 2009/45583; G06F 9/45558; G06F 2212/1044; G06F 2212/657; G06F 2009/4557; G06F 12/10

(57) ABSTRACT

An information processing apparatus includes: a memory; and a processor configured to: transfer data of a first memory regarding a migration source virtual machine which operates a first application on an operating system to a second memory of another information processing apparatus; stop the migration source virtual machine after completing transfer of the data of the first memory; and transfer data of an updated page which is stored in a part of the first memory used by the operating system and is updated while transferring the data of the first memory in a first order and transfer data of a first updated page which is stored in a part of the first memory used by a first application to the second memory in a next order, to resume the operations of the operating system and the first application when the transfer of the data of the updated page is completed.

### CROSS-REFERENCE TO RELATED APPLICATION

This application is based upon and claims the benefit of priority of the prior Japanese Patent Application No. 2017-132554, filed on Jul. 6, 2017, the entire contents of which are incorporated herein by reference.

### FIELD

The embodiments discussed herein are related to an information processing system, a control program of the information processing system, and a control method of the information processing system.

### BACKGROUND

A service system or an information processing system that provides a specific service is configured by a plurality of virtual machines deployed or created in a physical machine such as a server. In such an information processing system, when a work volume is increased or decreased or at the time of a repairing operation when a failure occurs, a live migration that executes the virtual machine in a separate physical machine is performed while an operation of the information processing system is continued. The live migration is one function of a hypervisor which is virtualization software.

The live migration is disclosed in the following patent documents.

Related techniques are disclosed in, for example, Japanese Laid-Open Patent Publication Nos. 2014-191752 and 2012-234564.

### SUMMARY

According to one aspect of the embodiments, an information processing apparatus includes: a memory; and a processor coupled to the memory and configured to: transfer data of a first memory regarding a migration source virtual machine which is generated by the processor and operates a first application on an operating system to a second memory of another information processing apparatus; stop the migration source virtual machine after completing transfer of the data of the first memory; and transfer data of an updated page which is stored in a part of the first memory which is used by the operating system and is updated while transferring the data of the first memory in a first order and transfer data of a first updated page which is stored in a part of the first memory which is used by a first application to the second memory of the another information processing apparatus in a next order, to resume the operation of the operating system and the operation of the first application in the another information processing apparatus when the transfer of the data of the updated page is completed, wherein a memory access to the first updated page is not executed until the data transfer of the first updated page is completed.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating a live migration of a virtual machine;

FIG. 2 is a flowchart of a live migration processing;

FIG. 3 is a diagram for describing the outline of the live migration processing;

FIG. 4 is a diagram for describing the outline of the live migration processing;

FIG. 5 is a diagram for describing the outline of the live migration processing;

FIG. 6 is a diagram illustrating the configuration of a migration source physical machine and a migration destination physical machine illustrated in FIG. 1;

FIG. 7 is a diagram illustrating a timing chart of non-priority transmission of FIG. 2 and the live migration of priority transmission according to an embodiment;

FIGS. 8A and 8B are a flowchart illustrating the operation of physical machines of a transmission source and a transmission destination in the live migration according to the embodiment;

FIG. 9 is a diagram illustrating an example of a priority and process ID management table;

FIG. 10 is a diagram illustrating an example of a memory page management table;

FIG. 11 is a diagram illustrating an example of a dirty page list;

FIG. 12 is a diagram illustrating a memory state when a migration destination virtual machine VMB_D is resumed;

FIG. 13 is a diagram illustrating the relationship among an MMU, an OS, and a hypervisor according to the embodiment;

FIG. 14 is a diagram illustrating the relationship between an address conversion table in the MMU and an MMU management table managed by the OS and the hypervisor;

FIG. 15 is a sequence chart illustrating the details of the live migration according to the embodiment;

FIG. 16 is a sequence chart illustrating the details of the live migration according to the embodiment;

FIG. 17 is a sequence chart illustrating the details of the live migration according to the embodiment; and

FIG. 18 is a sequence chart illustrating the details of the live migration according to the embodiment.

### DESCRIPTION OF EMBODIMENTS

In the live migration, first, while the hypervisor serving as a migration source continues to perform the operation of the information processing system, all data of a memory allocated to the virtual machine of the migration source among the memories of the migration source physical machine are transferred to a migration destination physical machine. In addition, the migration source hypervisor stores a memory page updated while the data of the memory is transferred. A memory at a transfer destination is a memory region allocated to the migration destination virtual machine created in the migration destination physical machine. Next, when transferring all data of the memory is completed, the migration source hypervisor suspends (pauses) the virtual machine of the migration source and thereafter, transfers only the updated memory page (dirty page) to the memory of the migration destination physical machine. In addition, after transferring of all data of the dirty page is completed, the migration destination hypervisor resumes the virtual machine created on the physical machine of the migration destination.

In the processing of the live migration described above, the virtual machine is temporarily suspended during the transfer of the dirty page. As a result, the information processing system is temporarily suspended and the service of the information processing system may not be continued. The information processing system may execute a plurality of business application programs (hereinafter, simply referred to as a business application or application) that provides a plurality of services, respectively. In this case, when the information processing system is suspended temporarily, the execution of all of the plurality of business applications stops.

However, the plurality of business applications may include applications with a high priority as well as applications with a low priority. In this case, when the virtual machine of the migration destination is resumed by waiting for the transfer of the dirty page of all business applications, a stop time is extended until the business of the application with the high priority is resumed.

Further, since the virtual machine operates the business application on an operating system (hereinafter, referred to as an OS), the memory region used by the virtual machine includes a memory region used by the OS and a memory region used by the business application. In the live migration described above, since the virtual machine of the migration destination is not resumed until the transfer of the dirty pages of both the memory regions used by the OS and the business application is completed, the stop time is extended until the business of the business application is resumed.

Therefore, an information processing system, a control program of the information processing system, and a control method of the information processing system which shorten the temporary suspension time of a virtual machine in the live migration may be provided.

[Outline of Live Migration]

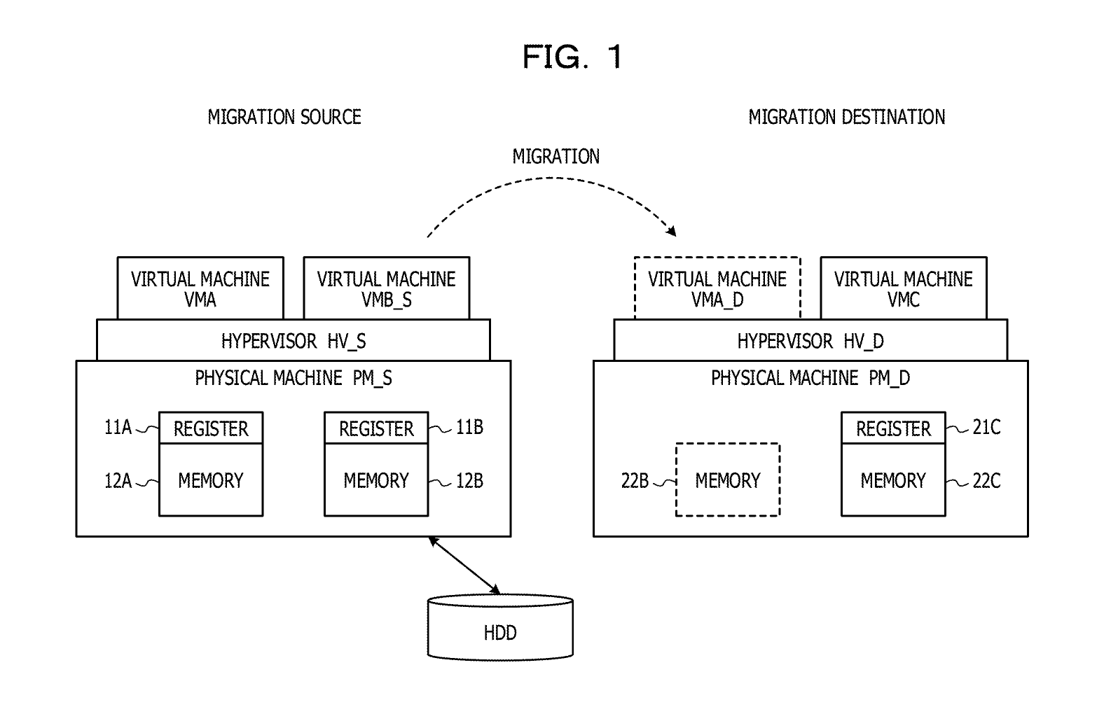

FIG. 1 is a diagram illustrating the live migration of a virtual machine. In FIG. 1, two virtual machines VMA and VMB_S are activated and being operated by control of a hypervisor HV_S which is virtualization software in a migration source physical machine PM_S. The hypervisor allocates memories 12A and 12B in the physical machine PM_S to the virtual machines VMA and VMB_S and when the respective virtual machines execute applications (not illustrated), registers 11A and 11B of a CPU are used. In addition, the migration source physical machine PM_S is accessed by the virtual machines VMA and VMB_S because a large capacity auxiliary memory such as a hard disk HDD is in a communicable state.

Meanwhile, one virtual machine VMC is activated and being operated by the hypervisor HV_D in a migration destination physical machine PM_D. In this state, the live migration processing is assumed to be performed in which the migration source virtual machine VMB_S is migrated from the migration source physical machine PM_S to the migration destination physical machine PM_D. Therefore, in the state illustrated in FIG. 1, the migration destination virtual machine VMB_D is not yet activated and a memory region 22B used by the migration destination virtual machine is not yet allocated.

When the hypervisor HV_S activates the virtual machine VMB_S, an OS, middleware, or applications in the hard disk HDD are expanded to the memory 12B. Then, when the virtual machine VMB_S starts operating, data is written to and read from the memory 12B and the register 11B in the CPU.

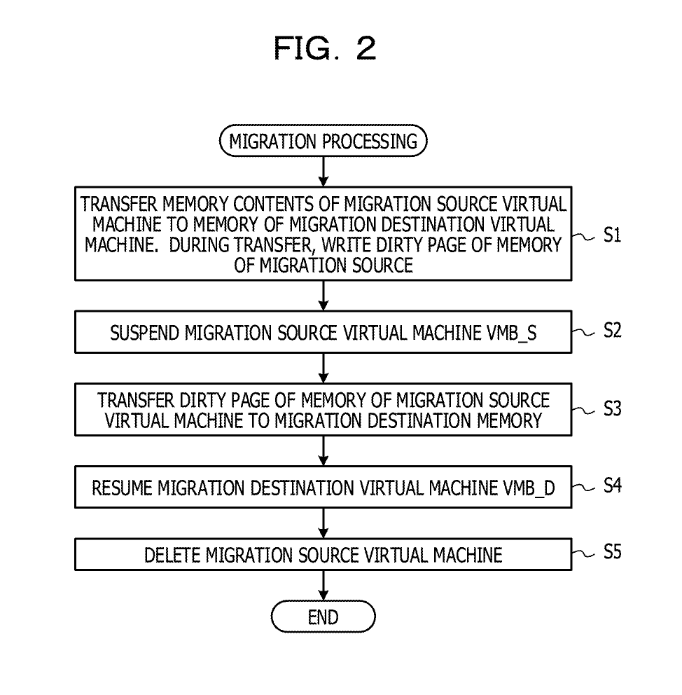

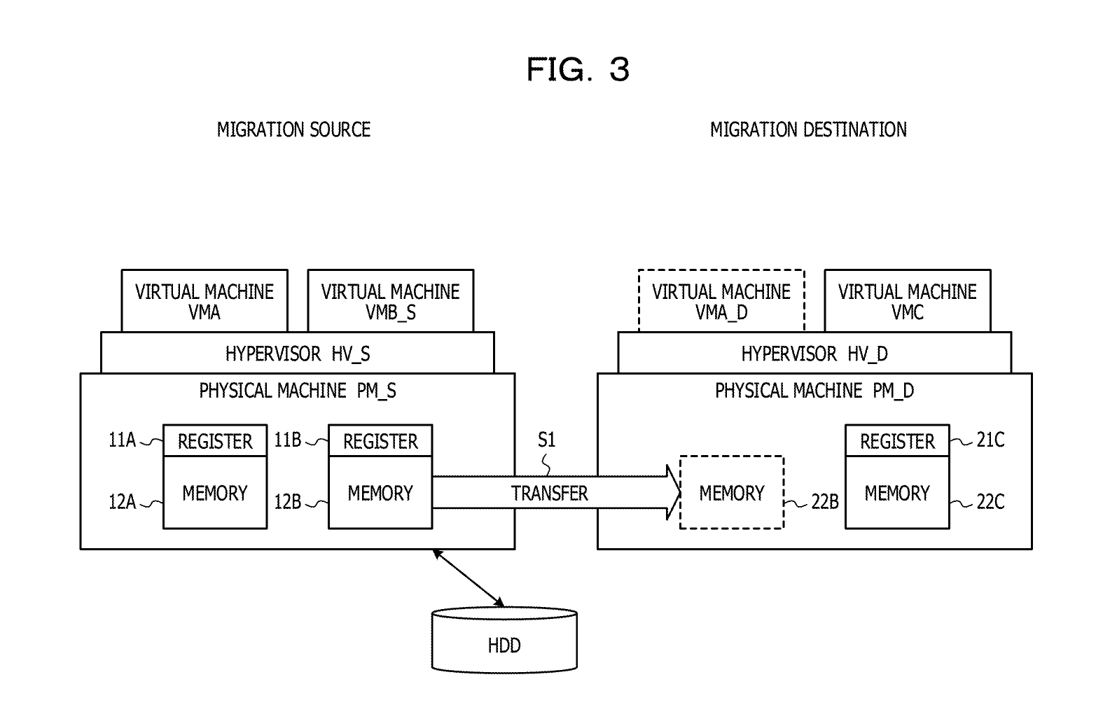

FIG. 2 is a flowchart of the live migration processing. Further, FIGS. 3, 4, and 5 are diagrams for describing the outline of the live migration processing. With reference to FIGS. 3 to 5, the outline of the processing of the live migration illustrated in FIG. 2 will be described.

First, the migration source hypervisor HV_S executes the live migration processing in response to a request for the live migration from a management server (not illustrated). The request for the live migration has information specifying a migration source physical machine and a migration source virtual machine (e.g., an IP address) along with information specifying a migration destination physical machine and a migration destination virtual machine. Alternatively, in the request for the live migration, an arbitrary physical machine may be permitted as the migration destination physical machine.

As illustrated in FIG. 3, the migration source hypervisor HV_S allows the migration destination hypervisor HV_D of the migration destination physical machine to secure the memory region 22B allocated to the migration destination virtual machine in the memory and to transfer and copy the data in the memory region 12B of the migration source virtual machine VMB_S to the memory region 22B of the migration destination virtual machine VMB_D (S1).

The data transfer processing to the memory takes for a relatively long processing time. Therefore, a transfer source hypervisor HV_S detects that the data is updated when writing to the memory occurs during the data transfer of the memory and writes a memory page in which the data is updated as a dirty page (S1).

Further, when all data in the memory region 12B has been transferred to the memory region 22B, the migration source hypervisor HV_S suspends (pauses) the migration source virtual machine VMB_S (S2). As a result, the operation of the migration source virtual machine VMB_S stops, so that the writing to the memory 12B or a change of the register 11B in the CPU does not occur.

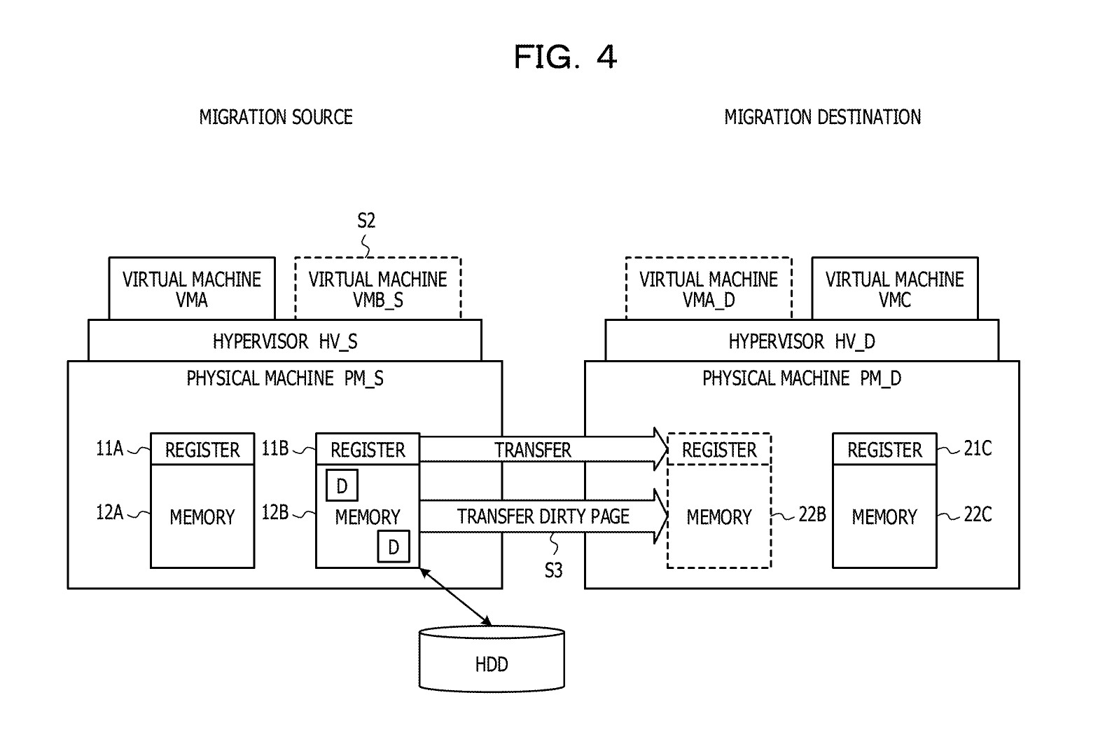

As illustrated in FIG. 4, after the migration source virtual machine is suspended, the migration source hypervisor HV_S transfers the data of the dirty page in the memory 12B of the migration source virtual machine and the data of the register 11B of the CPU to the memory region 22B of the migration destination virtual machine VMB_D and the register 21B of the CPU of the migration destination physical machine PM_D (S3).

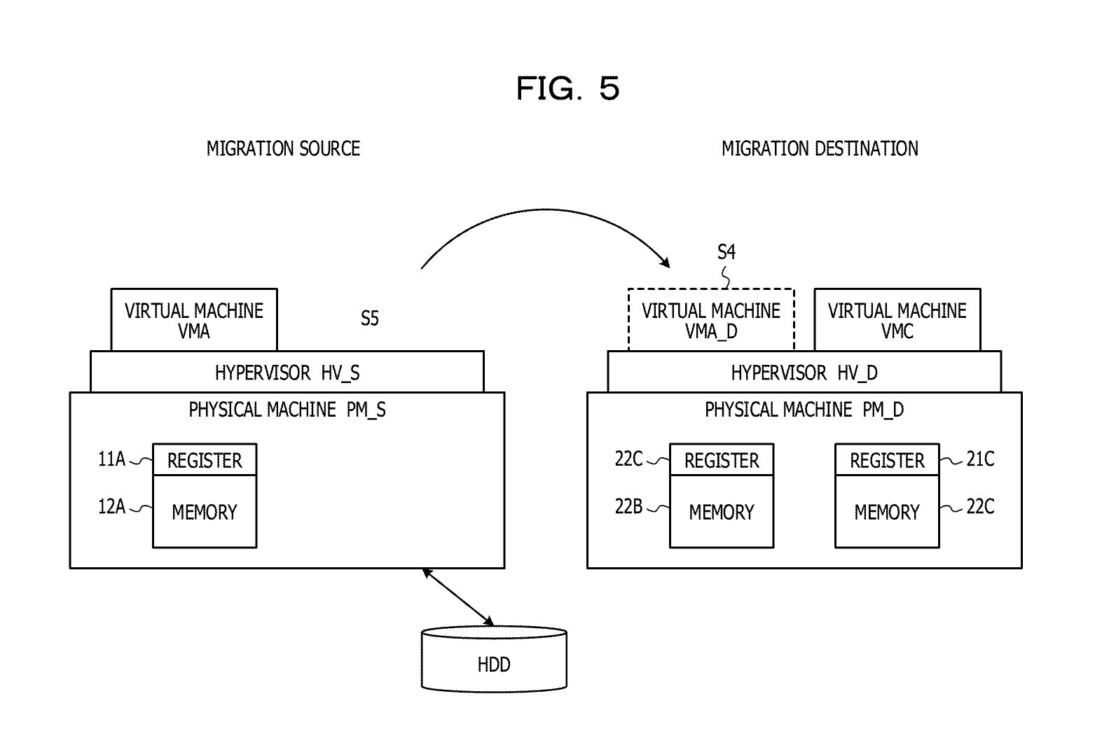

Further, as illustrated in FIG. 5, when the transfer of the data of the dirty page and the data of the CPU register is completed, the migration source hypervisor HV_S sends a transfer completion notification to the migration destination hypervisor HV_D. In response thereto, the migration destination hypervisor HV_D resumes the migration destination virtual machine VMB_D on the migration destination physical machine PM_D (S4).

In the resumption, unlike a normal resumption, the data is copied to and restored in the memory area 22B of the migration destination virtual machine VMB_D and the data is also restored in the CPU register. Therefore, when the migration destination hypervisor HV_D resumes the operation of an OS (not illustrated) of the migration destination virtual machine VMB_D, the operation of a business application is also resumed as the operation of the OS is resumed. Further, the migration destination virtual machine VMB_D becomes a state to access a hard disk HDD that stores the image data of the virtual machine and some retreat data.

Further, finally, the migration source hypervisor HV_S deletes the migration source virtual machine VMB_S (S5). As a result, the memory region 12B of the migration source virtual machine VMB_S is opened and the data of the registers in the CPU is also reset. This terminates the live migration.

During the process S3 of transferring the data in the dirty page and the data in the register of the CPU described above, the migration source virtual machine VMB_S and the migration destination virtual machine VMB_D also become inoperable and the operation of the business application of a virtual system configured in the virtual machine stops. Therefore, in the live migration processing, the transfer time of the dirty page in process S3 may be shortened desirably.

[Live Migration in Embodiment]

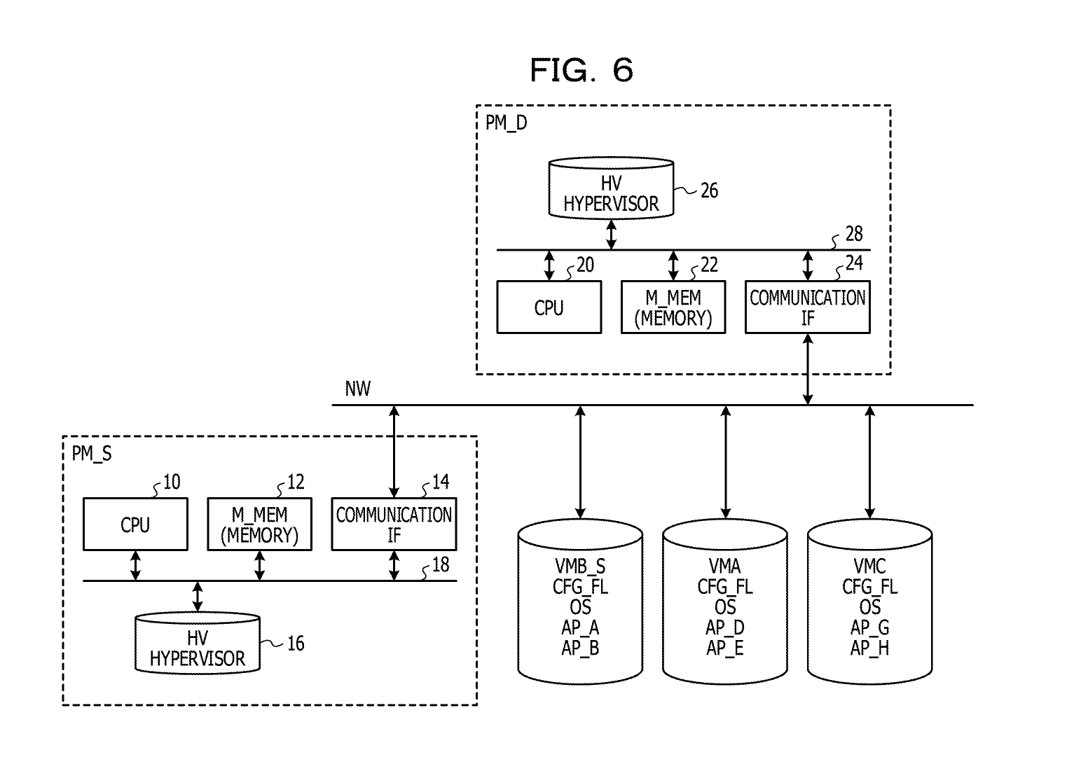

FIG. 6 is a diagram illustrating the configuration of a migration source physical machine and a migration destination physical machine illustrated in FIG. 1. The migration source physical machine PM_S includes a processor 10 which is a central processing unit (CPU), a main memory 12, a communication interface 14 such as a network interface card (NIC), and a large capacity auxiliary memory 16, which are mutually accessible via internal buses 18. The auxiliary memory 16 stores the migration source hypervisor HV_S or base software such as a host OS (not illustrated).

Similarly, the migration destination physical machine PM_D includes a processor 20 which is the CPU, a main memory 22, a communication interface 24, and a large capacity auxiliary memory 26, which are mutually accessible via the internal buses 28. The auxiliary memory 26 stores the migration destination hypervisor HV_D or the base software such as the host OS (not illustrated).

The migration source physical machine and the migration destination physical machine may communicate with each other via a network NW such as the Internet, an intranet, or a LAN. In addition, an image file 30 of the virtual machine VMB_S operating on the migration source physical machine PM_S and an image file 32 of the virtual machine VMA, and an image file 34 of the virtual machine VMC operating on the migration destination physical machine PM_D are communicably coupled to the network NW.

The image file 30 of the virtual machine VMB_S includes, for example, a configuration file CFG_FL having configuration information of the virtual machine (information such as a CPU usage rate, a memory amount, and a bandwidth allocated to the virtual machine), a guest OS, applications AP_A and AP_B, and the like. Image files 32 and 34 of the virtual machines VMA and VMC also have the same configuration as above. The image files are stored in a large capacity storage such as the hard disk or an SSD.

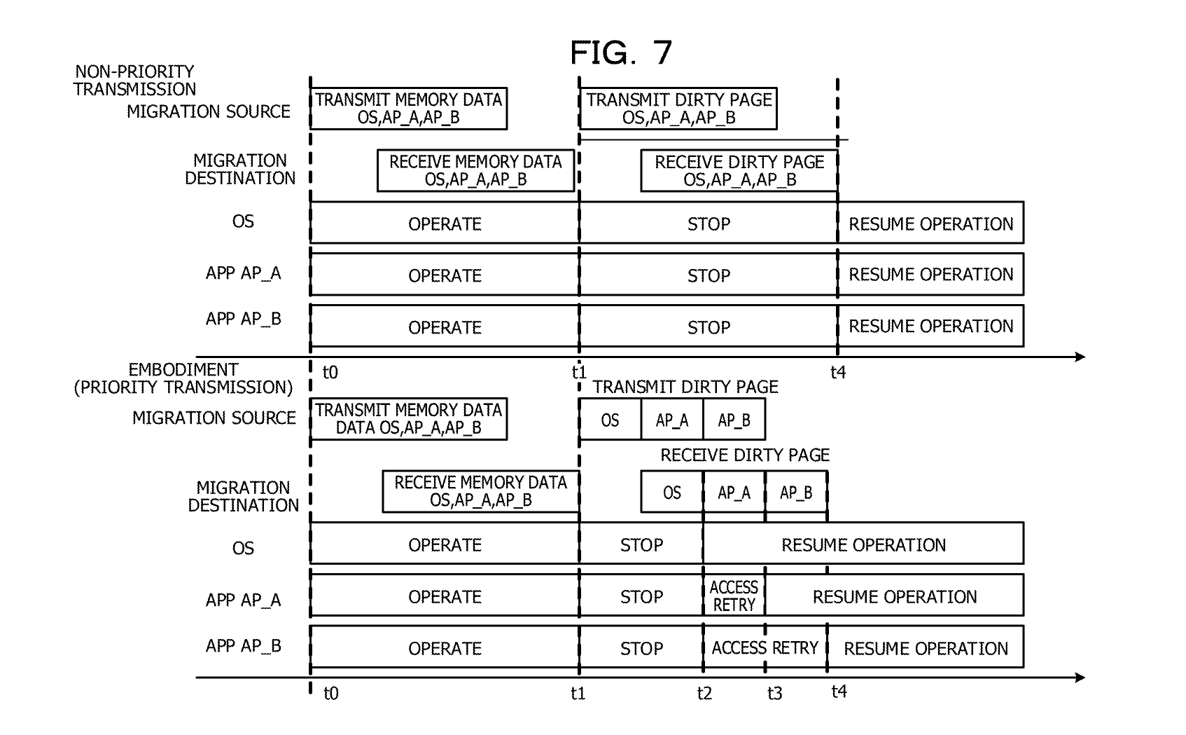

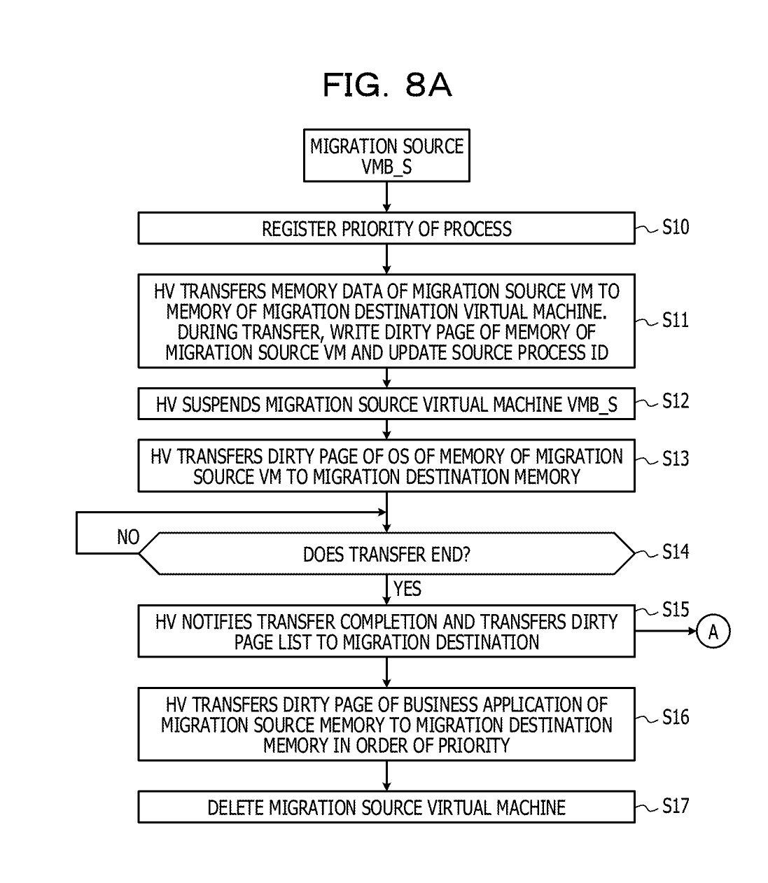

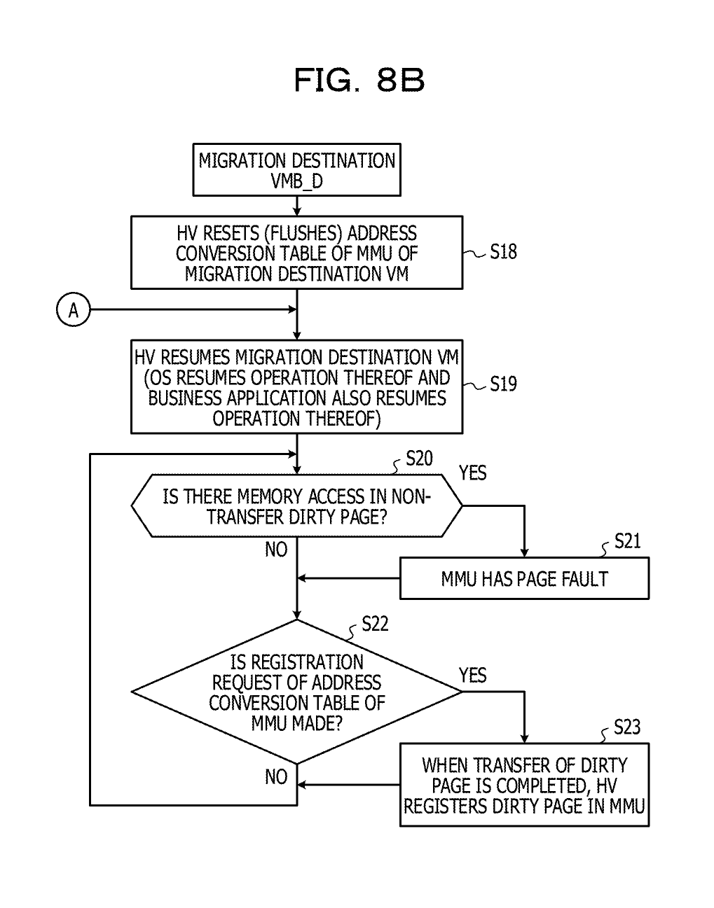

FIG. 7 is a diagram illustrating a timing chart of a live migration of non-priority transmission of FIG. 2 and priority transmission according to an embodiment. Further, FIGS. 8A and 8B are a flowchart illustrating the operations of physical machines of a transmission source and a transmission destination in the live migration according to the embodiment.

The timing chart for the non-priority transmission in FIG. 2 is disclosed in FIG. 7. Thus, at time t0, the migration source hypervisor transfers the data of the memory of the migration source virtual machine from the migration source physical machine to the migration destination physical machine and the migration destination physical machine receives the data of the memory. The data of the memory includes the guest OS and applications A and B deployed in the memory together with data used by, for example, the guest OS of the migration source virtual machine and applications A and B. While transferring the data of the memory, the OS of the migration source virtual machine and applications A and B continue to operate. As a result, the data is updated (written) in the memory region used by the OS of the virtual machine and applications A and B and the dirty page is generated.

At time t1, the migration source hypervisor suspends the migration source virtual machine, and the guest OS and applications A and B stop operating. Moreover, the migration source hypervisor transmits the data of the dirty page generated during the transfer of the data of the memory from the memory of the migration source physical machine to the memory of the migration destination, and the migration destination physical machine receives the data of the dirty page. The dirty page includes the updated data used by the guest OS of the migration source virtual machine and applications A and B.

Further, when transferring all dirty pages is completed, the migration destination hypervisor resumes the migration destination virtual machine at time t4.

Next, the live migration processing according to the embodiment will be described with reference to FIGS. 7 and 8. In the live migration of the embodiment, the migration source hypervisor executes the transfer of the dirty page in order of the priority. For example, the dirty page in the memory region used by the guest OS of the migration source virtual machine has the highest priority. Therefore, at time t1, the migration source hypervisor first transfers the data in the dirty page of the guest OS to the migration destination. In addition, the dirty pages of the memory regions used by a plurality of business applications are transferred in a descending order of the priority for business applications AP_A and AP_B.

Furthermore, when transferring the data in the dirty page of the guest OS is completed, the migration destination hypervisor resumes the migration destination virtual machine at time t2. At this time, the transfer of the data in the dirty pages of the business applications AP_A and AP_B is in an incomplete state. Further, at time t2, the guest OS may access the memory region because the transfer of the data in the dirty page of the guest OS is completed. Therefore, by resuming the migration destination virtual machine, the guest OS completely resumes the operation and accordingly, the operation of the business application is also resumed.

However, at an interval (between time t2 and time t3 for AP_A and between time t2 and time t4 for AP_B) until the transfer of the data in the dirty page of the business application is completed, the access to a dirty page of which transfer is incomplete by the business application is unsuccessful and access reattempt is repeated. In addition, until the data transfer of the dirty page to be accessed is completed, the business application waits for the access to the dirty page. Therefore, in the transfer destination virtual machine, the operation of the guest OS is completely resumed from time t2 and the operations of business applications AP_A and AP_B are resumed except for the access to the dirty page. Further, the access to the dirty page is resumed in an order from the dirty page in which the data transfer ends. When the data transfer of the dirty page is finally completed, the business operations AP_A and AP_B completely resume the operations of the respective business applications after time t3 and time t4, respectively.

When the live migration processing is described again based on the flowchart in FIGS. 8A and 8B, in the migration source virtual machine VM_S, a user of the migration source virtual machine registers the priority of a process of the business application (S10). The registration is performed by, for example, a command line interface in the guest OS of the migration source virtual machine by a user terminal. Then, the guest OS notifies the registration to the migration source hypervisor, and the migration source hypervisor stores the registration in the memory region thereof.

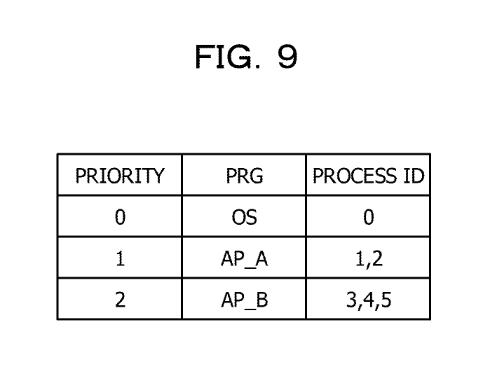

FIG. 9 is a diagram illustrating an example of a priority and process ID management table. The example of the table in FIG. 9 illustrates a correspondence between the priorities for the guest OS which is the program and business applications AP_A and AP_B, and process IDs. Herein, the priority is the priority of the business application. The priority and the process ID management table are stored in the memory region used by the migration source hypervisor (hypervisor memory), transferred even to the migration destination hypervisor, and similarly stored in the memory of the hypervisor.

Next, the migration source hypervisor allows the hypervisor of the migration destination physical machine to allocate the memory region of the migration destination virtual machine and transfers the data of the memory region allocated to the migration source virtual machine to the memory region of the migration destination virtual machine (S11). In addition, the migration source hypervisor detects a write access to the memory region of the migration source virtual machine and writes the dirty page in which the data is updated by writing and a process ID in which the data is updated during the data transfer of the memory (S11). The process ID is, for example, the process IDs of the guest OS and the business application. The process ID and the dirty page are written to a memory page management table and a dirty page list. Based on the writing, the migration source hypervisor transfers the data in the dirty page to the migration destination in a predetermined order as described below.

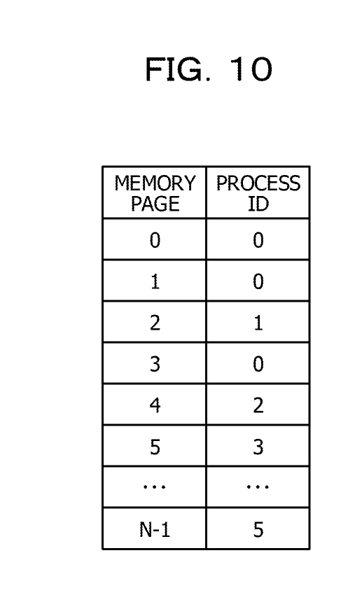

FIG. 10 is a diagram illustrating an example of a memory page management table. A main memory is constituted by a plurality of pages having a predetermined size. The process ID, which has accessed each page, in particular, has write-accessed each page, is written in the memory page management table. The process ID of the process of the guest OS is ID=0 as registered in the priority and process ID management table of FIG. 9. Further, the processes of the business applications AP_A and AP_B have process IDs of ID=1 and 2 and ID=3, 4, and 5, respectively. The process ID of the business application varies for each user. In the memory page management table in FIG. 10, the process ID to access each memory page is written.

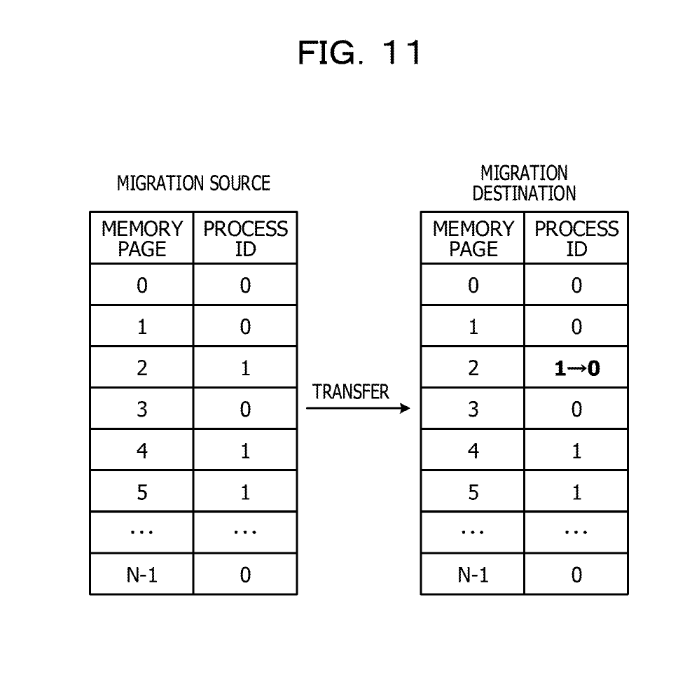

FIG. 11 is a diagram illustrating an example of a dirty page list. In FIG. 11, a list in which the migration source hypervisor writes data in an HV memory (left side) and a list in which the migration destination hypervisor writes the data in the HV memory (right side) are illustrated. The migration source hypervisor detects a write request to the memory during transferring the data of the memory so as to write dirty bit “1” (this refers to a page in which data is updated) to a memory page of a write request destination as illustrated in a left list.

The memory page management table and the dirty page list are stored in the memories of the migration source hypervisor and the migration destination hypervisor. By referring to the memory page management table and the dirty page list, it is determined whether the memory pages in the memory regions used by the migration source and destination virtual machines are the dirty page, and further determined which of the OS and the business application is used.

Referring back to FIGS. 8A and 8B, when the transfer of all data in the memory region of the migration source virtual machine is completed, the migration source hypervisor suspends (pauses) the migration source virtual machine VMB_S (S12). As a result, the operations of the guest OS of the migration source virtual machine and the business applications AP_A and AP_B stop.

Following the suspension, the migration source hypervisor transfers the data of the dirty page updated by the process of the guest OS of the migration source virtual machine (the page that is updated during the data transfer of the memory in the memory region used by the guest OS) to the memory region of the migration destination virtual memory (S13). The dirty page of the OS to be transferred may be detected by referring to the memory page management table and the dirty page list in FIGS. 9 and 10. Further, whenever the dirty page of the OS is transferred, a dirty flag of the dirty page list is changed to “0” (this indicates that as the transfer of the dirty page is completed, the corresponding dirty page is no longer the dirty page). In the meantime, the migration source virtual machine stops operating and the information processing system with the migration source virtual machine stops operating.

When the data transfer of the dirty page of the guest OS ends (YES in S14), the migration source hypervisor transfers the transfer completion notification of the dirty page of the OS and the dirty page list to the migration destination hypervisor (S15). Moreover, the migration source hypervisor transfers the dirty page of the business application in the memory region of the migration source virtual machine to the memory region of the migration destination virtual machine in order of the priority (S16). Further, when the transfer of all dirty pages is completed, the migration source hypervisor deletes the migration source virtual machine (S17).

Meanwhile, the migration destination hypervisor HV_D flushes (resets) an address conversion table of a memory management unit (MMU) of the migration destination virtual machine before or when receiving the data transfer completion notification of the dirty page of the guest OS. This is processing performed before newly activating or resuming the virtual machine. In the embodiment, using that the address conversion table of the MMU is flushed, the access to the dirty page which is not transferred is caused to be unsuccessful after the migration destination virtual machine is resumed. The details will be described below.

When the migration destination hypervisor HV_D receives the data transfer completion notification of the dirty page of the guest OS (S15), the migration destination hypervisor HV_D writes the dirty page list received simultaneously with the data transfer completion notification in the memory of the migration destination hypervisor. The migration destination hypervisor then resumes the migration destination virtual machine VMB_D (S19). As a result, the operation of the guest OS of the migration destination virtual machine is resumed and accordingly, the operations of the business applications AP_A and AP_B are also resumed even when the access to the dirty page is incomplete.

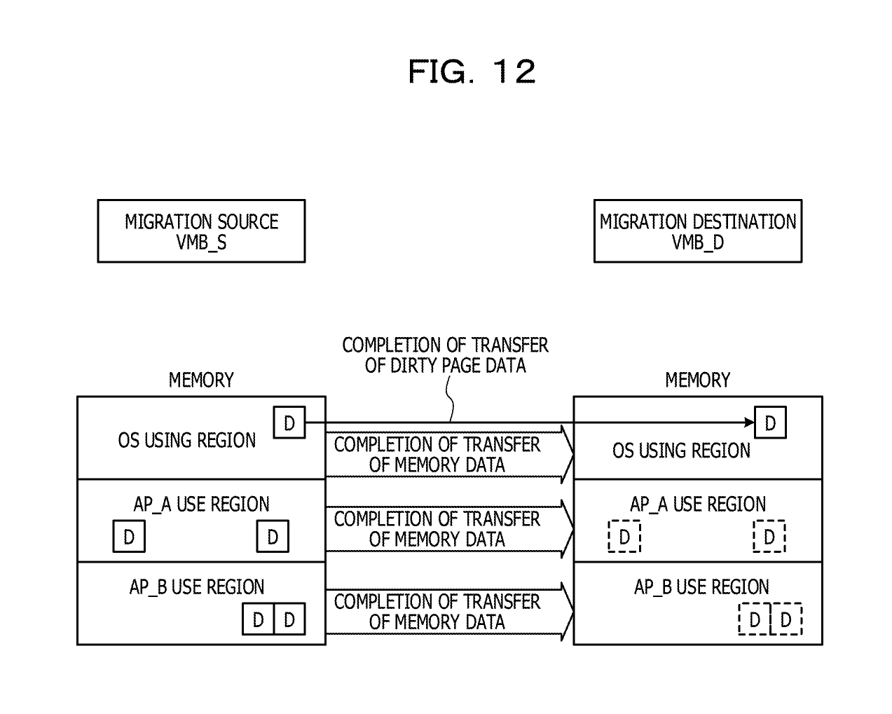

FIG. 12 is a diagram illustrating a memory state when a migration destination virtual machine VMB_D is resumed. When the migration destination virtual machine is resumed, an OS use region in the memory of the migration destination virtual machine also includes the dirty page, and as a result, all data becomes the same state as the memory of the migration source virtual machine. Meanwhile, in the use regions of the business applications AP_A and AP_B of the memory of the migration destination virtual machine, the data transfer of the memory is completed, but the data transfer of the dirty page is not completed. Therefore, the memory page (D in the drawing) in which the data of the dirty page is not transferred remains in the use regions of the business applications AP_A and AP_B. Further, the storage HDD in which the image file of the migration source virtual machine is written is changed to be accessible from the migration destination hypervisor.

In this state, when the migration destination hypervisor resumes the migration destination virtual machine, the guest OS almost completely resumes the operation in the migration source virtual machine using the data in the memory. As the guest OS resumes the operation, the operations of the business applications AP_A and AP_B are also resumed. However, the dirty page in which the data is not transferred exists in the memory regions used by the business applications AP_A and AP_B. Therefore, in the embodiment, the migration destination hypervisor allows the access to the dirty page in which the data is not transferred to be unsuccessful by using a function of the MMU function so as to control the successful access to the original dirty page after completing the data transfer.

Referring back to FIGS. 8A and 8B, when the migration destination virtual machine is resumed (S19) and thereafter, a memory access to the dirty page in which the data is not transferred occurs for the first time (S20), and the MMU outputs a page fault because the address conversion table in the MMU is flushed and a conversion destination physical address in the address conversion table is not registered (S21). The page fault is output to the migration destination hypervisor that manages the address conversion table and moreover, the migration destination hypervisor outputs the page fault to the guest OS that performs the memory access. In this regard, the guest OS outputs a registration request of a page which has the page fault in the address conversion table to the migration destination hypervisor (S22).

In response thereto, the migration destination hypervisor refers to the dirty page list to register the physical address in the address conversion table of the MMU and outputs a registration completion notification when the dirty page is transferred (S23). By such processing, the MMU executes an address conversion with respect to the subsequent access to the original dirty page from the guest OS to permit the access.

Meanwhile, when the dirty page is not transferred, the migration destination hypervisor returns the registration completion notification to the guest OS without registering the physical address in the address conversion table. By such processing, the MMU outputs the page fault again in response to the subsequent memory access (S20) to the dirty page which is not transferred from the guest OS (S21). The processes S20 and S21 are repeated until the transfer of the dirty page is completed, and as a result, the failure in the memory access to the dirty page which is not transferred from the business application is repeated.

When the data transfer of the dirty page of the business application is received, the migration destination hypervisor changes the dirty bit of the dirty page list to “0”. The dirty bit is changed similarly to the change from “1” of the dirty bit of memory page “2” illustrated in FIGS. 11 to “0”. Therefore, as the data transfer of the dirty page is sequentially performed, registration in the address conversion table of the MMU is performed in response to the memory access to the original dirty page of the business application AP_A having the high priority, and as a result, the operation of the business application AP_A becomes finally complete. In addition, since the dirty page of the business application AP_A is data-transferred earlier than the business application AP_B, an incomplete operation state of the high-priority business application AP_B is shortened.

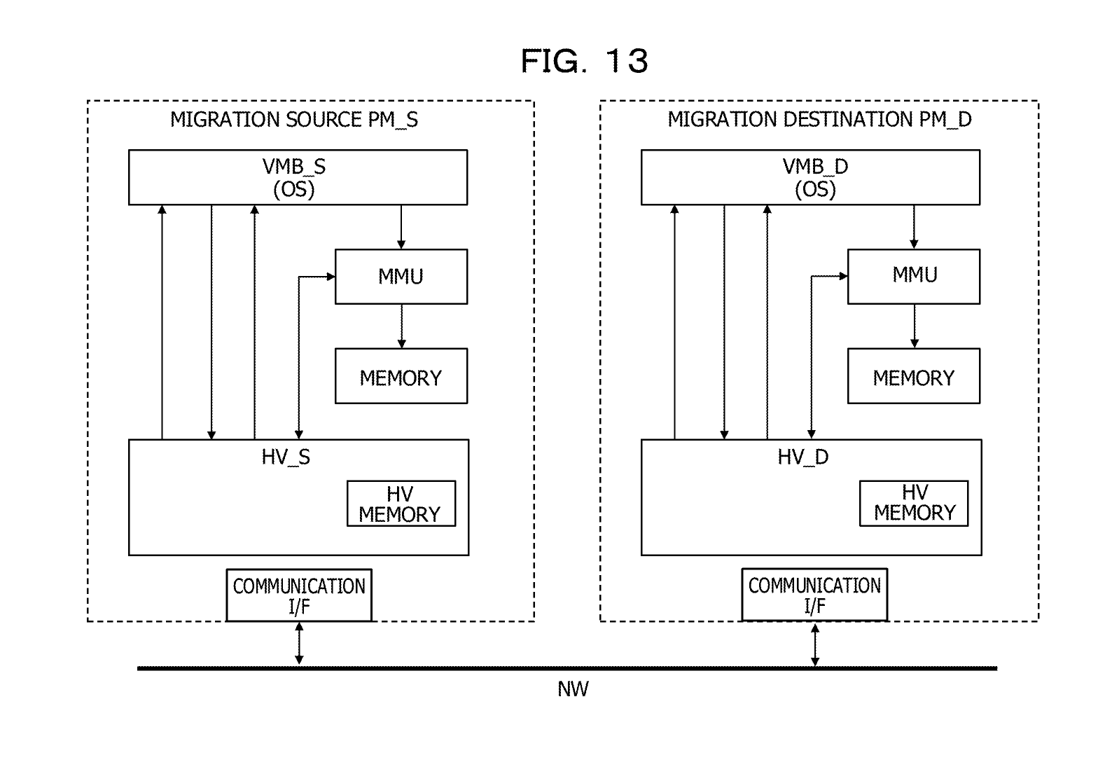

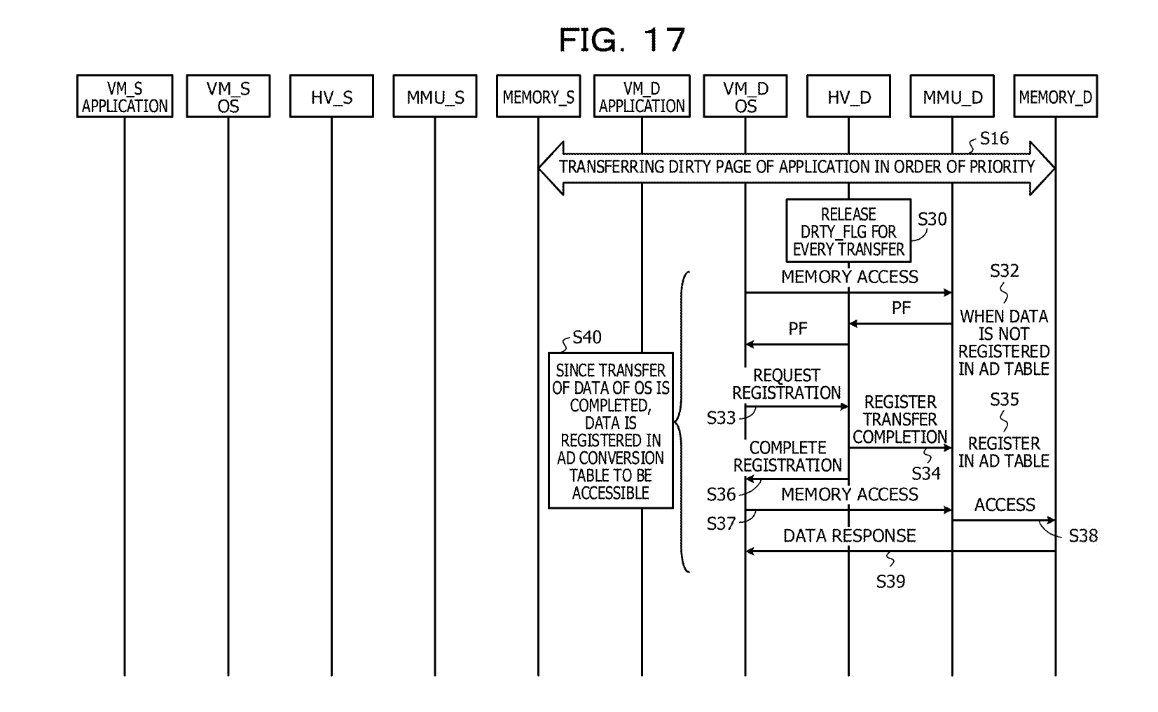

FIG. 13 is a diagram illustrating the relationship among an MMU, an OS, and a hypervisor according to the embodiment. Broken lines in FIG. 17 indicate the migration source physical machine PM_S and the migration destination physical machine PM_D. Both the physical machines also have the OSs of the virtual machines VM_S and VM_D, the MMU, the memory (main memory), and the hypervisors HV_S and HV_D, and each of the physical machines PM_S and PM_D is communicably coupled with a communication interface via the network NW. Both hypervisors maintain the memory region (HV memory) used by the hypervisor in the respective main memories.

The MMU has, for example, an address conversion function that converts the virtual address into the physical address or a memory protection function that prohibits writing to the memory. With respect to the address conversion function, when the guest OS of the virtual machine performs the memory access regardless of the migration source and the migration destination, the memory access is input into the MMU and the MMU converts the virtual address of the access destination into the physical address of the main memory to access the main memory with the physical address. In this case, when the physical address is not registered with respect to the virtual address, the MMU notifies the OS of the page fault via the hypervisor. In response to the notification, the OS requests that the hypervisor register the physical address for the virtual address. Since the hypervisor manages the allocation of the main memory to the virtual machine, the hypervisor registers the physical address for the virtual address and returns the registration completion notification to the OS in response to the registration request. Thereafter, when the OS accesses the same virtual address again, the MMU converts the virtual address into the physical address to permit the access to the main memory.

In the embodiment, the migration destination hypervisor monitors the data transfer of the dirty page, performs registration when the dirty page is transferred with respect to the registration request of the physical address, and outputs the registration completion notification without registration when the dirty page is not transferred. As a result, the memory access to the memory page in which the dirty page is not transferred may be caused to be unsuccessful by using the page fault function of the MMU. In addition, after the transfer of the dirty page is completed, the transfer destination hypervisor registers the physical address in the MMU in response to the physical address registration request from the OS, so that the memory access to the dirty page of which transfer is completed may be caused to be successful.

Meanwhile, with regard to the memory protection function, in a case where the hypervisor sets protection to prohibit writing to the memory region used by the virtual machine with respect to the MMU, when the write request is made from the OS, the MMU outputs the page fault based on the set protection. In response to the page fault, the hypervisor changes the dirty bit of the dirty page list to “1” of the update completion and releases the protection of the memory page with respect to the MMU. Then, when the OS issues the write request to the same memory page again, the MMU does not output the page fault because the protection is released. As a result, writing to the memory page is executed. By such a function, the hypervisor may detect the creation of the dirty page in which the data of the memory is being transferred and further, write the created dirty page to the dirty bit of the dirty page list.

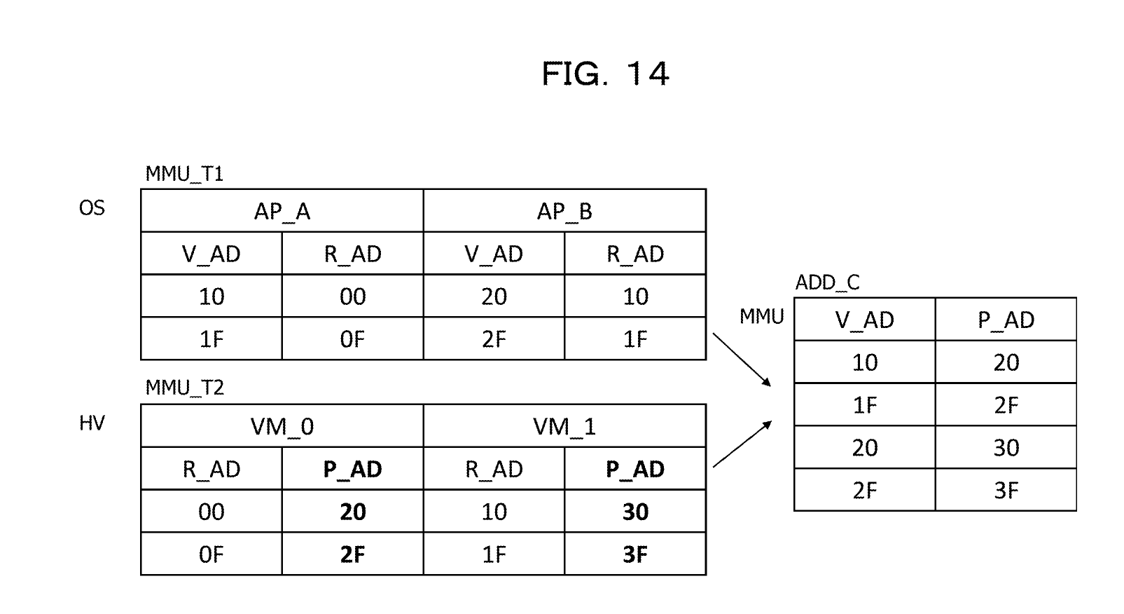

FIG. 14 is a diagram illustrating the relationship between an address conversion table in the MMU and an MMU management table managed by the OS and the hypervisor. In a virtualization system that creates the virtual machine, the address conversion table in the MMU is created according to the MMU management table of the OS and the MMU management table of the hypervisor.

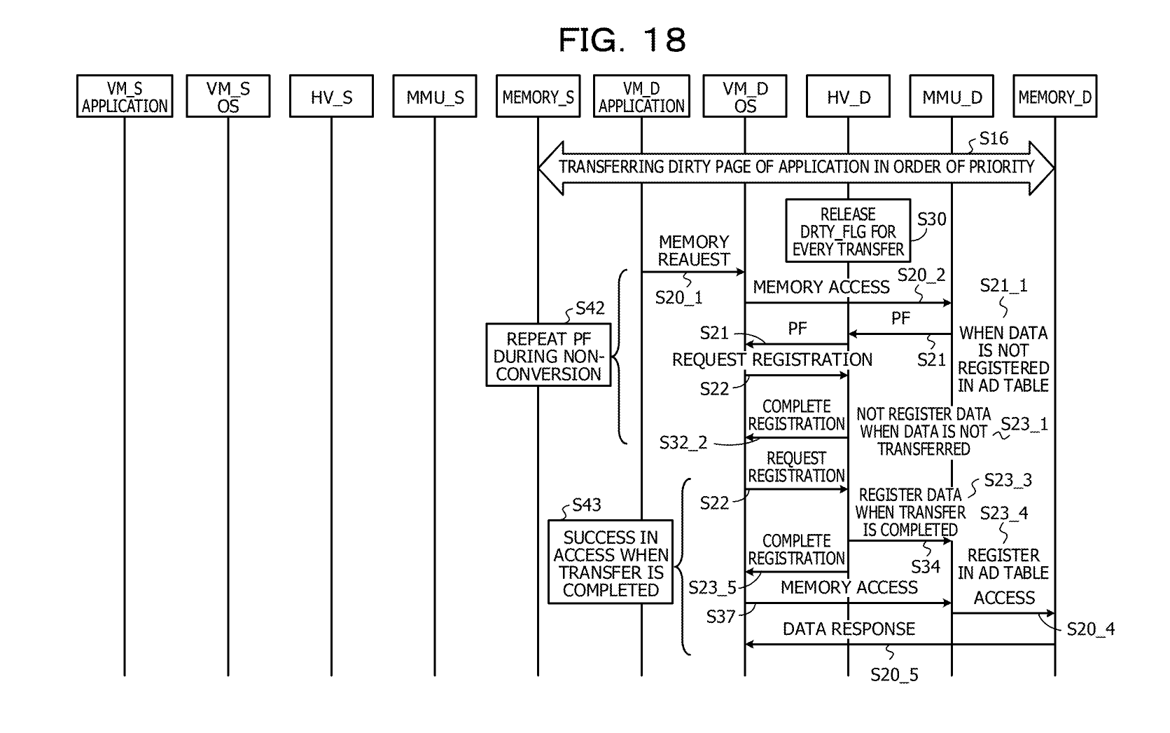

The lower bits of the virtual address are not changed even when the virtual address is converted to the physical address, but the upper bits of the virtual address are converted to the physical address. Thus, FIG. 18 illustrates the correspondence between the upper bits of the virtual address and the physical address.

First, an MMU management table MMU_T1 managed by the OS compares and stores a virtual address V_AD which is an access destination address of a memory request of the application and a real address R_AD corresponding thereto. Further, the MMU management table MMU_T1 managed by the OS stores the correspondence between the virtual address V_AD and the real address R_AD for each of the applications AP_A and AP_B.

Meanwhile, an MMU management table MMU_T2 managed by a hypervisor HV writes the correspondence between the real address R_AD and the physical address P_AD for each of virtual machines VM_0 and VM_1. The hypervisor HV manages the memory region of the virtual machine created on the physical machine because a predetermined virtual machine VM_0 is prevented from accessing the data of the memory of the other virtual machine VM_1. Therefore, when the hypervisor newly activates the virtual machine or when the hypervisor resumes the migration destination virtual machine as the migration destination hypervisor, the physical address P_AD in the MMU management table MMU_T2 is newly registered.

Meanwhile, an address conversion table ADD_C in the MMU stores the correspondence between the virtual address V_AD and the physical address P_AD of the applications AP_A and AP_B. The address conversion table ADD_C of the MMU is stored, for example, in a main memory and a part thereof is stored in a cache unit as a transactional lookaside buffer TLB.

As described above, the hypervisor has a function to control the registration of the physical address of the address conversion table of the MMU. In the embodiment, by such a function, the access to the dirty page in which the data is not transferred by the application immediately after the migration destination virtual machine is resumed is caused to be unsuccessful and the access is caused to be successful after the data is transferred.

[Details of Live Migration]

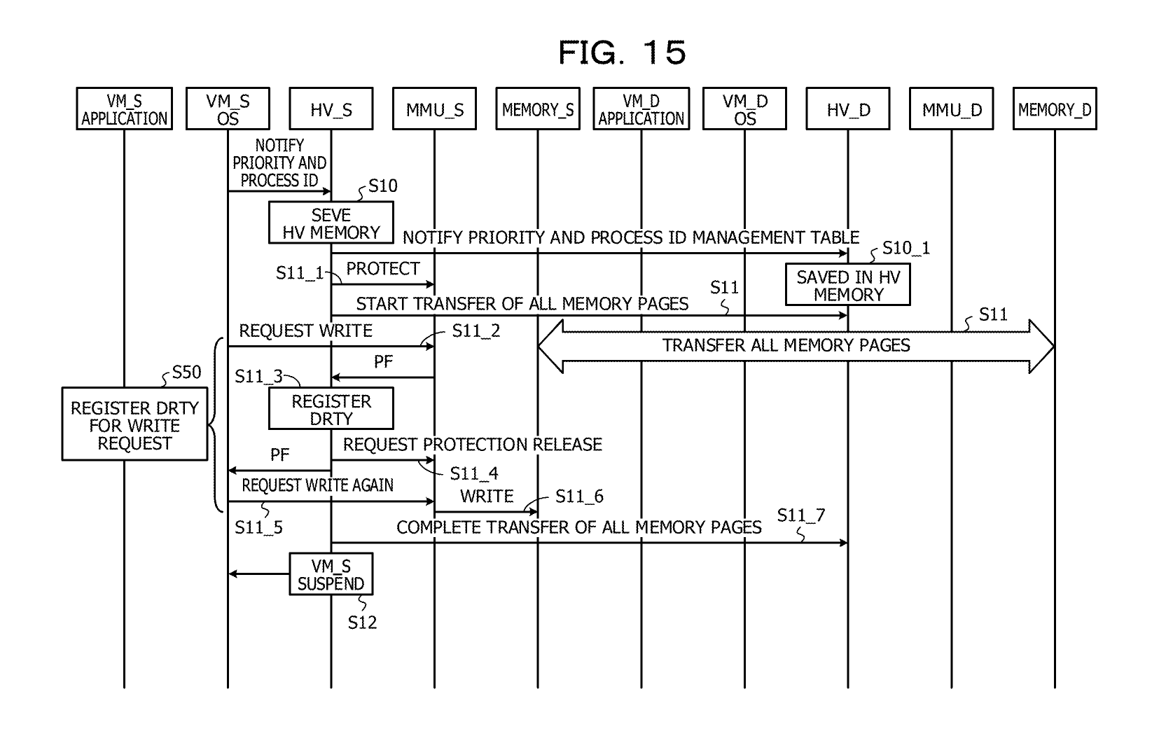

FIGS. 15 to 18 are sequence charts illustrating the details of the live migration according to the embodiment. The details of the live migration are described with reference to process numbers S10 to S23 of the flowchart of FIGS. 8A and 8B.

In FIG. 15, as a preparatory process for the live migration, the user registers a process of the application with a higher priority from the command line interface of the OS of the migration source virtual machine VM_S (S10). In response thereto, the OS notifies the migration source hypervisor of the high-priority process ID and stores the process ID in the priority and process ID management table of the hypervisor memory (FIG. 9).

Further, when the virtual machine is migrated to a separate physical machine, the migration source hypervisor HV_S transfers the priority and process ID management table to the migration destination hypervisor HV_D and stores the priority and process ID management table in the hypervisor memory (S10_1).

Furthermore, in the case of the live migration, the migration source hypervisor transmits the memory page management table for the memory region used by the migration source virtual machine to the migration destination hypervisor so as to allow the migration destination hypervisor to secure the memory region used by the migration destination virtual machine.

Next, the migration source hypervisor HV_S starts transferring all the memory page data in the memory region used by the migration source virtual machine to the memory allocated to the migration destination virtual machine of the migration destination physical machine (S11). At the same time or before the start, the migration source hypervisor HV_S sets a write protection with respect to the entire memory region of the migration source virtual machine in the MMU (S11_1).

As a result, when the write request is output to the MMU in the OS of the migration source virtual machine (S11_2) during the data transfer of the memory (S11), the MMU outputs a page fault PF to the migration source hypervisor based on the setting of the write protection. As a result, the migration source hypervisor detects that the write request to the memory is made and writes the dirty bit in the memory page of the write destination in the dirty page list as “1” (updated) (S11_3). At the same time, the process ID of the write request source is written in the memory page management table (FIG. 10).

The migration source hypervisor then requests the MMU to release the setting of the write protection to the memory page of the write request and outputs the page fault PF to the OS that requests the write (S11_4). As a result, when the OS outputs the write request again (S11_5), the MMU outputs the write request to the memory through address conversion (S11_6). As a result, the write is executed and the data is updated, so that the dirty page is created.

The migration source hypervisor detects the writing to the memory of the migration source virtual machine by a series of processes S50 of the write protection setting S11_1 to the write request to the memory S11_6 described above so as to write the dirty page updated by the write and the process ID of the write request source in the dirty page list and the memory page management table.

Next, when the data transfer of all the memory pages in the memory region of the migration source virtual machine is completed (S11_7), the migration source hypervisor suspends the migration source virtual machine VM-S (S12).

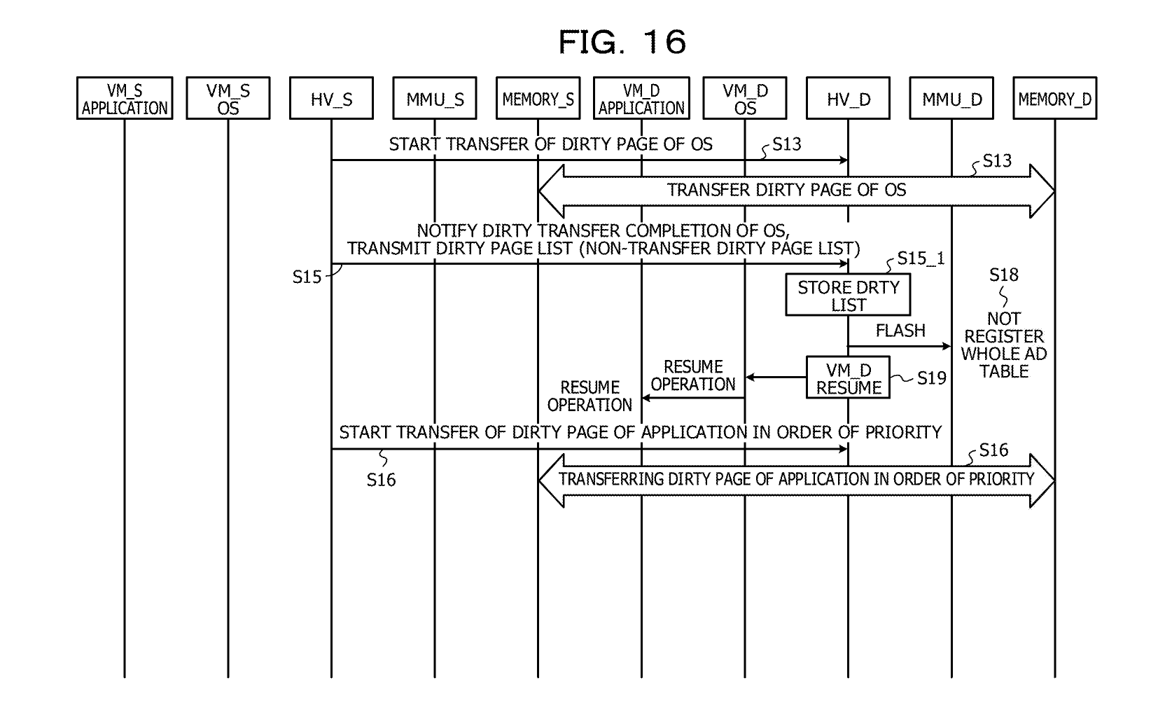

Referring to FIG. 16, the migration source hypervisor HV_S starts to transfer the data of the dirty page in the memory region used by the guest OS of the migration source virtual machine (S13). The migration source hypervisor extracts a page which is a page of the process ID (ID=0) of the OS in the memory page management table (FIG. 10) and in which the dirty flag in the dirty page list (FIG. 11) is “1” and starts to transfer the data of the page to the memory region of the migration destination virtual machine. The migration source hypervisor changes the corresponding dirty flag in the dirty page list to “0” (transfer is completed) when the data transfer of the dirty page is completed.

When the data transfer of the dirty page of the OS is completed, the migration source hypervisor transfers the dirty page transfer completion notification attached with the dirty page list to the migration destination hypervisor HV_D (S15) and stores the dirty page transfer completion notification of the OS in the hypervisor memory (S15_1).

The migration destination hypervisor HV_D then flushes the physical address of the address conversion table in the MMU and makes all physical addresses of the migration destination virtual machine in the address conversion table a state of absence of registration (S18). The migration destination hypervisor then resumes the migration destination virtual machine VM_D (S19). As a result, the guest OS of the migration destination virtual machine resumes the operation thereof and accordingly, the business applications AP_A and AP_B also resume the operations thereof.

Meanwhile, the transfer source hypervisor HV_S starts a data transfer of the dirty page in the memory region used by the business application in order of the priority (S16). When it is supposed that the priority of the business application AP_A is set to be higher than the priority of the AP_B, the transfer source hypervisor HV_S first starts data transfer from the data page of the high-priority business application AP_A.

FIG. 17 illustrates the process of the memory request to the OS using memory region by the OS S40 while the dirty page of the application is data-transferred in order of the priority. First, the transfer destination hypervisor HV_D changes the dirty flag of the page in which the transfer of the dirty page list is completed to “0” (transfer is completed) whenever the transfer of the dirty page of the application is completed (S30).

Further, when the guest OS outputs the memory request to the MMU in the transfer destination virtual machine (S31), since the physical address corresponding to the virtual address of the memory request is not registered in the address conversion table (S32), the MMU outputs the page fault PF to the hypervisor HV_D, and as a result, the page fault PF is transferred to the OS. Therefore, when the OS outputs the registration request of the physical address to the hypervisor HV_D (S33), the dirty flags of all memory pages of the memory region used by the OS are “0” (transfer is completed) in the dirty page list, the hypervisor registers the physical address corresponding to the virtual address of the memory request in the MMU (S34 and S35). In addition, the hypervisor returns the registration completion to the OS (S36).

Then, when the OS outputs the memory request to the MMU again on the same page (S37), the MMU performs an address conversion and the access to the memory is executed by the converted physical address (S38). As a result, the OS receives a data response from the memory (S39).

As described above, the page fault occurs in the OS by the first memory request, but the registration in the address conversion table of the MMU is then performed and the subsequent memory request is not unsuccessful. Therefore, the OS completely resumes the operation thereof.

FIG. 18 illustrates the processes of the memory request to the memory region by the application S42 and S43 while the dirty page of the application is data-transferred in an order of the priority. Herein, the transfer destination hypervisor HV-D also changes the dirty flag of the dirty page list to “0” (transfer is completed) whenever the transfer of the dirty page is completed (S30).

Then, in the transfer destination virtual machine, when the application issues the memory request (S20_1), the OS outputs the memory request to the MMU (S20_2). Initially, since the physical address in the address conversion table in the MMU is not yet registered, the MMU outputs the page fault PF to the hypervisor HV_D and, furthermore, the PF is transferred to the OS (S21).

Therefore, when the OS outputs the registration request of the physical address to the hypervisor HV_D (S22), the hypervisor does not register the physical address (S23_1) and returns the registration completion to the OS (S23_2) when the dirty bit of the memory page of the memory request is in a state in which the data is not transferred. As a result, the process from the memory request (S20_1) by the application to the registration completion (S23_2) S42 is repeated during the non-transfer of the dirty page and the memory request is unsuccessful by the page fault.

Meanwhile, when the transfer of the dirty page of the memory page of the memory request is completed, the hypervisor registers the physical address in the MMU (S23_3 and S23_4) and returns the registration completion to the OS (S23_5). As a result, when the subsequent memory request from the application is output to the MMU through the OS (S20_3), the MMU performs an address conversion and the memory access is thus executed (S20_4), and the OS receives the data response from the memory (S20_5). When the data transfer of the dirty page is completed as described above, the access to the page is successful (S43). Therefore, the operations after the resuming of the business applications AP_A and AP_B are incomplete operations in which the memory access to the page is unsuccessful while the data transfer of the dirty page is incomplete. However, the operations are migrated to complete operations as the data transfer of the dirty page is performed.

As described above, in the case of the live migration according to the embodiment, after the migration source virtual machine is suspended, the data transfer of the dirty page is performed first with respect to the OS and thereafter, the data transfer of the dirty page is performed with respect to the business application according to the priority. In addition, at the time when transferring the data in the dirty page of the memory of the OS is completed, the migration destination virtual machine is resumed. As a result, a time from suspension of the migration source virtual machine up to resumption of the migration destination virtual machine may be shortened. Further, after resuming the operation of the application after resuming the migration destination virtual machine, the memory request to the dirty page by the business application is temporarily unsuccessful, but as the data transfer of the dirty page is completed, a failure probability of the memory request by the business application is lowered. Therefore, after the data transfer of all dirty pages of the application is completed, the migration destination virtual machine is resumed to quickly start the operation of the application.

In the embodiment described above, the memory request to the dirty page in which the data is not transferred after resuming the migration destination virtual machine is caused to be unsuccessful by using the registration of the physical address of the MMU. However, instead of using the registration of the physical address in the MMU, a function to detect the memory request by the application in the OS and notify the migration destination hypervisor of the detected memory request may be set to allow the migration destination hypervisor to fail in the memory request to the dirty page in which the data transfer is not completed.

What is claimed is:

1. An information processing apparatus comprising:
a memory; and
a processor coupled to the memory and configured to:
transfer data of a first memory regarding a migration source virtual machine which is generated by the processor and operates a first application on an operating system to a second memory of another information processing apparatus;
stop the migration source virtual machine after completing transfer of the data of the first memory; and
transfer data of an updated page which is stored in a part of the first memory which is used by the operating system and is updated while transferring the data of the first memory in a first order and transfer data of a first updated page which is stored in a part of the first memory which is used by a first application to the second memory of the another information processing apparatus in a next order, to resume the operation of the operating system and the operation of the first application in the another information processing apparatus when the transfer of the data of the updated page is completed,
wherein a memory access to the first updated page is not executed until the data transfer of the first updated page is completed.

2. The information processing apparatus according to claim 1, wherein the processor transfers a second updated page in a part of the first memory which is used by a second application having a lower priority than the first application to the second memory in a next order of the first updated page to resume an operation of the second application together with resuming the operation of the first application, and a memory access to the second updated page is not executed until transfer of the second update page is completed at the time of resuming the operation of the operating system.

3. The information processing apparatus according to claim 1, wherein
an address conversion table which is used for a conversion of a virtual address into a physical address and is provided in the another information processing apparatus is reset when the data transfer of the updated page is completed, address conversion information of the first updated page is registered in the address conversion table when the data transfer of the first updated page of the operating system is completed, when the address conversion information of the first updated page of a destination of a memory access is not registered in the address conversion table, the memory access fails without performing an address conversion, and when the registration is completed, the memory access succeeds by performing the address conversion.

4. The information processing apparatus according to claim 1, wherein the processor, when a write access to the first memory occurs during transferring the data of the first memory,
writes generation source identification information of a write access in a first management table in association with a page of a write access destination by distinguishing whether a generation source of the write access is the operating system or the first application,
writes that the page is updated in a second management table in association with the page of the write access destination, and
executes a data transfer of the updated page of the operating system and the first updated page to the second memory by referring to the first management table and the second management table.

5. The information processing apparatus according to claim 4, wherein the processor transfers the second management table to the another information processing apparatus until the data transfer to the second memory of the another information processing apparatus of the first updated page starts, and
the first updated page in which the data transfer is completed is written in the second management table whenever the data transfer of the first updated page is completed, and whether the memory access to the first updated page succeeds is controlled based on writing of completion of the data transfer of the first updated page.

6. The information processing apparatus according to claim 2, wherein the processor stores priority information and transfers the priority information to the another information processing apparatus in response to priority setting of the first and second applications.

7. The information processing apparatus according to claim 6, wherein the processor distinguishes and stores each of a page which is used by the operating system and pages which are used by the first and second applications among a plurality of pages in the first memory.

8. A non-transitory computer-readable storage medium storing a computer executable control program that causes a computer to execute a process, the process comprising:
transferring, by a first physical machine, data of a first memory of regarding a migration source virtual machine which is generated by the first physical machine and operates a first application on an operating system to a second memory of a second physical machine among a plurality of physical machines;
stopping the migration source virtual machine after completing transfer of the data of the first memory; and
transferring data of an updated page which is stored in a part of the first memory which is used by the operating system and is updated while transferring the data of the first memory in a first order and transferring data of a first updated page which is stored in a part of the first memory which is used by the first application to the second memory of the second physical machine in a next order to resume the operation of the operating system and the operation of the first application in the second physical machine when the transfer of the data of the updated page is completed,
wherein a memory access to the first updated page is not executed until the data transfer of the first update page is completed.

9. The non-transitory computer-readable storage medium according to claim 8, further comprising:
transferring a second updated page in a part of the first memory which is used by a second application having a lower priority than the first application to the second memory in a next order of the first updated page to resume an operation of the second application together with resuming the operation of the first application,
wherein a memory access to the second updated page is not executed until transfer of the second update page is completed at the time of resuming the operation of the operating system.

10. The non-transitory computer-readable storage medium according to claim 8, wherein
an address conversion table which is used for a conversion of a virtual address into a physical address and is provided in the second physical machine is reset when the data transfer of the updated page is completed, address conversion information of the first updated page is registered in the address conversion table when the data transfer of the first updated page of the operating system is completed, when the address conversion information of the first updated page of a destination of a memory access is not registered in the address conversion table, the memory access fails without performing an address conversion, and when the registration is completed, the memory access succeeds by performing the address conversion.

11. The non-transitory computer-readable storage medium according to claim 8, further comprising:
when a write access to the first memory occurs during transferring the data of the first memory, writing generation source identification information of a write access in a first management table in association with a page of a write access destination by distinguishing whether a generation source of the write access is the operating system or the first application;
writing that the page is updated in a second management table in association with the page of the write access destination; and
executing a data transfer of the updated page of the operating system and the first updated page to the second memory by referring to the first management table and the second management table.

12. The non-transitory computer-readable storage medium according to claim 11, further comprising:
transferring the second management table to the second physical machine until the data transfer to the second memory of the second physical machine of the first updated page starts,
wherein the first updated page in which the data transfer is completed is written in the second management table whenever the data transfer of the first updated page is completed, and whether the memory access to the first updated page succeeds is controlled based on writing of completion of the data transfer of the first updated page.

13. The non-transitory computer-readable storage medium according to claim 9, further comprising:
storing priority information and transferring the priority information to the second physical machine in response to priority setting of the first and second applications.

14. The non-transitory computer-readable storage medium according to claim 13, further comprising:
distinguishing and storing each of a page which is used by the operating system and pages which are used by the first and second applications among a plurality of pages in the first memory.

15. A control method of an information processing system comprising:
transferring, by a first physical machine, data of a first memory of regarding a migration source virtual machine which is generated by the first physical machine and operates a first application on an operating system to a second memory of a second physical machine among the plurality of physical machines;
stopping the migration source virtual machine after completing transfer of the data of the first memory; and
transferring data of an updated page which is stored in a part of the first memory which is used by the operating system and is updated while transferring the data of the first memory in a first order and transferring data of a first updated page which is stored in a part of the first memory which is used by the first application to the second memory of the second physical machine in a next order, to resume the operation of the operating system and the operation of the first application in the second physical machine when the transfer of the data of the updated page of the operating system is completed,
wherein a memory access to the first updated page is not executed until the data transfer of the first update page is completed.

16. The control method according to claim 15, further comprising:
transferring a second updated page in a part of the first memory which is used by a second application having a lower priority than the first application to the second memory in a next order of the first updated page to resume an operation of the second application together with resuming the operation of the first application,
wherein a memory access to the second updated page is not executed until transfer of the second update page is completed at the time of resuming the operation of the operating system.

17. The control method according to claim 15, wherein an address conversion table which is used for a conversion of a virtual address into a physical address and is provided in the second physical machine is reset when the data transfer of the updated page is completed, address conversion information of the first updated page is registered in the address conversion table when the data transfer of the first updated page of the operating system is completed, when the address conversion information of the first updated page of a destination of a memory access is not registered in the address conversion table, the memory access fails without performing an address conversion, and when the registration is completed, the memory access succeeds by performing the address conversion.

18. The control method according to claim 15, further comprising:
when a write access to the first memory occurs during transferring the data of the first memory, writing generation source identification information of a write access in a first management table in association with a page of a write access destination by distinguishing whether a generation source of the write access is the operating system or the first application;
writing that the page is updated in a second management table in association with the page of the write access destination; and
executing a data transfer of the updated page of the operating system and the first updated page to the second memory by referring to the first management table and the second management table.

19. The control method according to claim 18, further comprising:
transferring the second management table to the second physical machine until the data transfer to the second memory of the second physical machine of the first updated page starts,
wherein the first updated page in which the data transfer is completed is written in the second management table whenever the data transfer of the first updated page is completed, and whether the memory access to the first updated page succeeds is controlled based on writing of completion of the data transfer of the first updated page.

20. The control method according to claim 16, further comprising:
storing priority information and transferring the priority information to the second physical machine in response to priority setting of the first and second applications.
